(19) United States
(12) Patent Application Publication
(10) Pub. No.: US 2013/0106736 A1
(43) Pub. Date: May 2, 2013

(54) LAMINATING STRUCTURE, ELECTRONIC DEVICE HAVING THE LAMINATING STRUCTURE AND LAMINATING METHOD THEREOF

(71) Applicants: Yuh-Wen Lee, Zhubei (TW); Fengming Lin, Fuzhou (CN); Keming Ruan, Ningde (CN)

(72) Inventors: Yuh-Wen Lee, Zhubei (TW); Fengming Lin, Fuzhou (CN); Keming Ruan, Ningde (CN)

(21) Appl. No.: 13/456,231

(22) Filed: Apr. 26, 2012

(30) Foreign Application Priority Data
Nov. 2, 2011 (CN) 201110347279.7

(51) Int. Cl. G06F 3/041; G02B 5/30; B44C 1/22; B32B 3/02; B32B 37/12; B32B 38/00

(52) U.S. Cl. 345/173; 156/292; 156/275.5; 216/20; 428/157; 359/488.01

(57) ABSTRACT

A laminating structure, an electronic device having the laminating structure and a laminating method thereof are provided. The laminating structure comprises a bonding frame disposed on a peripheral area of a first substrate, wherein surface of the bonding frame comprises a plurality of protrusions and an interspace that is provided between each two adjacent protrusions for containing an overflow portion of a liquid adhesive. The present disclosure utilizes a method of forming a patterned bonding frame to prevent adhesive from overflowing during the process of laminating substrates. Therefore, in the present disclosure, steps of adhesive scraping and adhesive cleaning are omitted so as to reduce labor and material costs.

### BACKGROUND OF THE INVENTION

This Application claims the benefit of the People's Republic of China Application No. 201110347279.7, filed on Nov. 2, 2011.

### FIELD OF THE INVENTION

The present disclosure relates to a laminating technology, and more particularly to a laminating structure, an electronic device having the laminating structure and a laminating method thereof.

### DESCRIPTION OF THE RELATED ART

Optically clear adhesives (OCA) have been widely applied and used in electronic equipments such as mobile phones, personal digital assistants (PDS), global positioning system (GPS) or pocket personal computers (PC) and the like, as a laminating material between various internal components of electronic equipments. Generally, optically clear adhesives are categorized into solid adhesives and liquid adhesives. With the development of liquid adhesive materials, solid adhesives have been gradually abandoned and liquid adhesives have been used extensively. Liquid adhesives cause an adhesive overflow problem during a laminating process. In practice, the adhesive overflow problem is normally solved by adhesive scraping and adhesive cleaning methods that cost a great deal of labor power and materials.

### SUMMARY OF THE INVENTION

The present disclosure provides a laminating structure, an electronic device having the laminating structure and a laminating method thereof, that utilizes a method of forming a patterned bonding frame to prevent adhesive overflowing during a process of laminating substrates. Therefore, steps of adhesive scraping and adhesive cleaning can be omitted from the whole laminating process so as to reduce labor and material costs.

The present disclosure provides a laminating structure comprising: a bonding frame disposed on a peripheral area of a first substrate, wherein surface of the bonding frame comprises a plurality of protrusions, and an interspace is provided between each two adjacent protrusions for containing an overflow portion of a liquid bonding adhesive.

The present disclosure further provides an electronic device having the foregoing laminating structure, comprising: a first substrate; a bonding frame disposed on peripheral area of the first substrate, wherein surface of the bonding frame comprises a plurality of protrusions and an interspace is provided between each two adjacent protrusions for containing an overflow portion of a liquid bonding adhesive; and a second substrate laminated to the first substrate by the liquid bonding adhesive.

The present disclosure further provides a laminating method of the electronic device comprising following steps: disposing a bonding frame on peripheral area of a first substrate, wherein surface of the bonding frame is formed with a plurality of protrusions and an interspace is provided between each two adjacent protrusions; coating a liquid adhesive on a laminating area surrounded by the bonding frame, wherein the interspace between the protrusions contains the overflow portion of the liquid adhesive; and laminating a second substrate and the first substrate.

Since a laminating structure of the present disclosure has been utilized, wherein the laminating structure has a plurality of protrusions and an interspace is provided between adjacent protrusions, adhesive overflow problem would not occur during the process of laminating the first substrate and the second substrate. Steps of adhesive scraping and adhesive cleaning can be omitted from the whole laminating process, and labor power and material costs can be reduced. In addition, bubbles can be exhausted from the interspace, thereby reducing defects of products caused by bubbles appearing during the laminating process.

### BRIEF DESCRIPTION OF THE DRAWINGS

FIG. 1 is a top plan view diagram of a bonding frame formed on a peripheral area of a first substrate in accordance with an embodiment of the present disclosure;

FIG. 2 is a lateral view diagram of a bonding frame formed on a peripheral area of a first substrate in accordance with the present disclosure;

FIG. 3 is a decomposition view diagram of a laminating structure of an electronic device in accordance with the present disclosure;

FIG. 4 is a lateral view diagram of a laminating structure of an electronic device in accordance with the present disclosure; and

FIG. 5 is a lateral view diagram of a liquid adhesive spreading on first substrate and filling in a bonding frame in accordance with the present disclosure.

### DETAILED DESCRIPTION OF THE EMBODIMENTS

For those skilled in the art to further understand the present disclosure, numerous embodiments are described below, annexing drawings to minutely illustrate the matters of the present disclosure and the purpose thereof.

In accordance with the usual meaning of “a” and “the” in patents, reference, for example, to “a” interspace or “the” interspace is inclusive of one or more interspace. In this application, use of the singular includes the plural and vice versa unless specifically stated otherwise, for example, a term “interspace” includes singular and plural forms. Section headings used herein are for organizational purposes only, and are not to be construed as limiting the subject matter described.

Detailed description of the present disclosure will be discussed in the following embodiments, which are not intended to limit the scope of the present disclosure, but still can be adapted for other applications. While drawings are illustrated in detail, it would be appreciated that quantity of the disclosed components could be greater or less than disclosed.

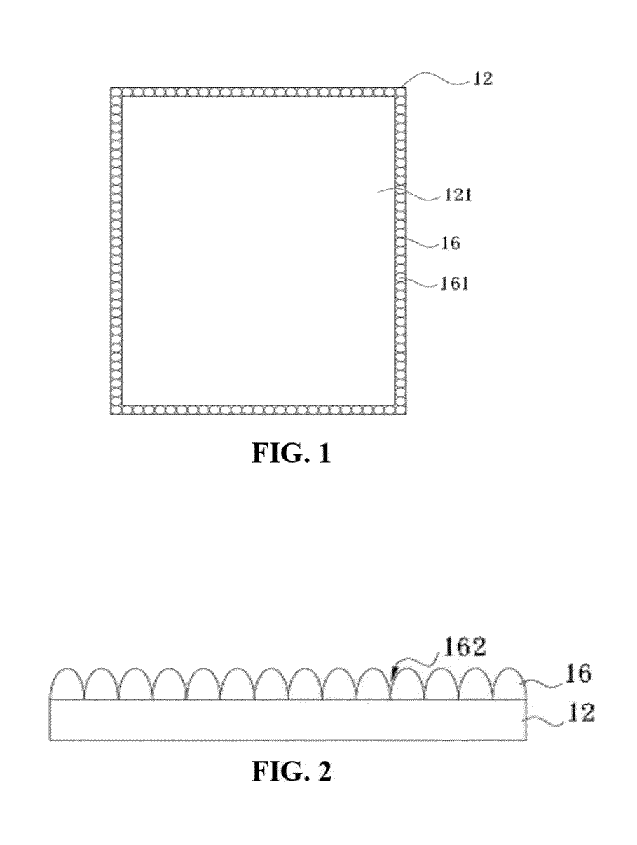

FIG. 1 and FIG. 2 show laminating structures of the present disclosure. FIG. 1 is a top plan view diagram of a bonding frame formed on a peripheral area of a first substrate in accordance with an embodiment of the present disclosure. FIG. 2 is a lateral view diagram of a bonding frame formed on a peripheral area of a first substrate in accordance with the present disclosure. The laminating structure comprises a bonding frame 16 disposed on a peripheral area of a first substrate 12 and rounded into a laminating area 121 on the first substrate 12 for coating a liquid adhesive so that the liquid adhesive is spread over the laminating area 121 to form a liquid bonding layer for laminating another substrate. The bonding frame 16 is a high polymer adhesive having elasticity such as epoxy resin or acrylic resin.

In one embodiment of the present disclosure as shown in FIG. 1, surface of the bonding frame 16 comprises a plurality of protrusions 161 arched up along a direction that is perpendicular to the first substrate 12 and formed regular patterns, for example, the protrusions 16 are connected with each other in a bead chain-like conformation. In an embodiment, the protrusions 16 are indented, but not limited to and can also be in any other similar regular pattern. The protrusions 16 are continuous and aligned with equal spaces and interconnected to form the bonding frame 16 surrounding the foregoing laminating area 121. In an embodiment of the present disclosure as shown in FIG. 2, an interspace 162 is provided between each two adjacent protrusions 161. When the liquid adhesive on the laminating area 121 is overflowing, the interspace 162 contains the overflow portion of the liquid adhesive, and the liquid adhesive is filled in the interspace 162 simultaneously to exhaust bubbles from the interspace 162, so as to reduce the defects of products caused by bubbles. In an embodiment of the present disclosure, the foregoing laminating structure can be disposed in an electronic device can be a touch panel or a display panel.

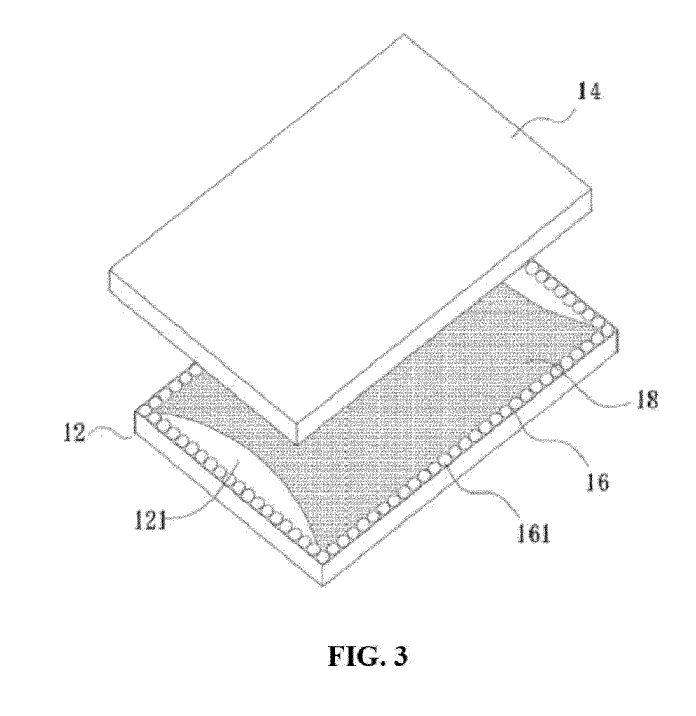

FIG. 3 and FIG. 4 illustrate a decomposition view diagram and a side view diagram respectively of an electronic device that has a foregoing laminating structure. In one embodiment of the present disclosure, an electronic device comprises: a first substrate 12, a second substrate 14, a bonding frame 16, and a liquid adhesive 18.

In another embodiment of the present disclosure, an electronic device comprises a touch panel. The touch panel can be applied in the electronic device such as mobile phones, pocket personal computers (PC) or global positioning system (GPS) and the like, as an input device or as an interface for users to operate. When the electronic device is a touch panel, a first substrate 12 is a touch substrate formed with a touch sensing layer, and a second substrate 14 is a cover corresponding to the touch substrate. The touch sensing layer can be a capacitive touch sensing layer or a resistive touch sensing layer. The electronic device can also be a display panel. Similarly, the display panel can be applied to the electronic device. When the electronic device is a display panel, the first substrate 12 is a light filtering substrate and the second substrate 14 is a thin film transistor substrate or a polarizing substrate corresponding to the light filtering substrate. The first substrate 12 and the second substrate 14 can be inorganic substrates such as glass, or organic substrates such as plastic.

In an embodiment of the present disclosure, structure of the bonding frame 16 is same as that of the foregoing embodiments, namely the bonding frame 16 is disposed on the peripheral area of the first substrate 12, and the surface of the bonding flame 16 comprises a plurality of protrusions 161. An interspace 162 is provided between each two adjacent protrusions 161 for containing the overflow portion of the liquid adhesive 18 so as to avoid the liquid adhesive 18 overflowing to exterior of the electronic device. The liquid adhesive 18 is spread over the laminating area 121 so that the second substrate 14 is laminated with the first substrate 12 by the liquid adhesive 18.

Further, the protrusions of the bonding frame 16 are indented and form a bead chain-like structure, and are continuously aligned with equal spaces. The bonding frame 16 is a high polymer adhesive having elasticity such as epoxy resin or acrylic resin. The adhesive is solidified by ultraviolet or infrared irradiation or baking.

Further, once the first substrate 12 and the second substrate 14 have been laminated, the electronic device is manufactured. The laminating structure would help the electronic device to overcome the adhesive overflow problem so as to omit processes of adhesive scraping or adhesive cleaning. Therefore, the process described in the present disclosure is simplified and the labor cost is reduced. The problem of generating bubbles during the laminating process is solved simultaneously in the present disclosure.

In an embodiment of the present disclosure, a laminating method of the foregoing electronic device is described below. FIG. 1 and FIG. 2 show laminating structures of an electronic device. The laminating method includes preparing a first substrate 12. Further, disposing a bonding frame 16 on peripheral area of the first substrate 12, wherein methods of disposing the bonding frame 16 comprise printing, dispensing, ejecting, and chemical etching on the surface thereof to form a plurality of protrusions 161, and providing an interspace 162 between each two adjacent protrusions. The formed protrusions 162 are indented or have a bead chain-like structure and are continuously aligned with equal spaces. In addition, the bonding frame 16 is a high polymer adhesive having elasticity such as epoxy resin or acrylic resin.

Further, partly solidifying the bonding frame 16 by ultraviolet, infrared irradiation or baking and the like methods to stable patterns formed by the bonding frame 16. The solidification said herein is not a complete solidification, so that the bonding frame 16 still has certain elasticity to laminate the peripheral area of the second substrate 14.

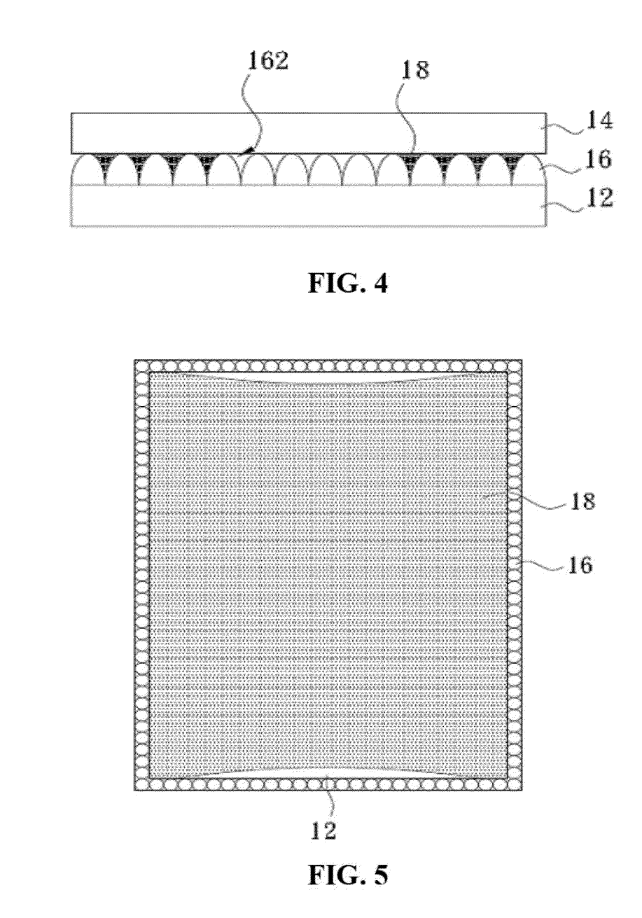

In an embodiment of the present disclosure, the method further comprises coating a liquid adhesive 18 on a laminating area 121 that is surrounded by the bonding frame 16 on the first substrate 12, as shown in FIG. 5. The interspace 162 between the protrusions 161 is used for containing the overflow portion of the liquid adhesive 18, and for preventing the liquid adhesive 18 from overflowing to exterior of the electronic device.

In an embodiment of the present disclosure, the method further comprises laminating the first substrate 12 and the second substrate 14. The liquid adhesive 18 diffuses to surround and flow towards the bonding frame 16 under pressure. The interspace 162 between the protrusions 161, that are adjacent to the bonding frame 16 have smaller elasticity so that the liquid adhesive 18 is locked in the interspace 162 of the bonding frame 16 and the laminating area 121 of the first substrate 12 without overflowing, and so that the air molecules can be exhausted from the interspace 162 simultaneously.

Further, the method comprises laminating the second substrate 14 to the first substrate 12 by the liquid adhesive 18. As shown in FIG. 4, once the first substrate 12 and the second substrate 14 are laminated, the liquid adhesive 18 is solidified by ultraviolet, infrared irradiation or baking and the like methods, and the bonding frame 16 is solidified completely at the same time, thereby accomplishing the laminating step of the first substrate 12 and the second substrate 14 as shown in FIG. 4.

An advantage of the present disclosure is to provide a laminating structure, an electronic device having the laminating structure and a laminating method thereof, which utilizes a method of forming a patterned bonding frame to prevent an adhesive from overflowing during a process of laminating substrates. Therefore, steps of adhesive scraping and adhesive cleaning can be omitted from the whole laminating process, so as to reduce labor and material costs.

Although the present disclosure refers to the above described embodiments, it is not intended to limit the scope of the present disclosure. It is apparent to those skilled in the art that modifications and substitutions to the described embodiments may be made without departing from the spirit and scope of the present disclosure. Accordingly, the scope of the present disclosure is further defined by the attached claims.

What is claimed is:

1. A laminating structure, comprising:
a bonding frame disposed on peripheral area of a first substrate, wherein a surface of the bonding frame comprises a plurality of protrusions and an interspace that is provided between each two adjacent protrusions for containing overflow portion of a liquid adhesive.

2. The laminating structure of claim 1, wherein the first substrate further comprises a laminating area surrounded by the bonding frame, and the liquid adhesive is spread over the laminating area to form a liquid adhesive layer for laminating a second substrate to the first substrate.

3. The laminating structure of claim 2, wherein the laminating structure is disposed in an electronic device comprising a touch panel or a display panel.

4. The laminating structure of claim 1, wherein the protrusions are continuously aligned with equal spaces.

5. The laminating structure of claim 1, wherein the protrusions are indented or have a bead chain-like structure.

6. The laminating structure of claim 1, wherein the bonding frame is a high polymer adhesive having elasticity.

7. The laminating structure of claim 1, wherein the bonding frame is formed from an adhesive.

8. An electronic device having a laminating structure, comprising:
a first substrate;
a bonding frame disposed on a peripheral area of the first substrate, wherein a surface of the bonding frame comprises a plurality of protrusions and an interspace that is provided between each two adjacent protrusions for containing an overflow portion of a liquid adhesive; and
a second substrate laminated with the first substrate by the liquid adhesive.

9. The electronic device having the laminating structure of claim 8, wherein the electronic device is a touch panel, and wherein the first substrate is a touch substrate formed with a touch sensing layer, and wherein the second substrate is a cover corresponding to the touch substrate.

10. The electronic device having the laminating structure of claim 9, wherein the touch sensing layer comprises a capacitive touch sensing layer or a resistive touch sensing layer.

11. The electronic device having the laminating structure of claim 8, wherein the electronic device is a display panel, and wherein the first substrate is a light filtering substrate, and wherein the second substrate is a thin film transistor substrate or a polarizing substrate corresponding to the light filtering substrate.

12. The electronic device having the laminating structure of claim 8, wherein the protrusions are continuously aligned with equal spaces.

13. The electronic device having the laminating structure of claim 8, wherein the protrusions are indented or have a bead chain-like structure.

14. The electronic device having the laminating structure of claim 8, wherein the bonding frame is a high polymer adhesive having elasticity.

15. A laminating method of an electronic device, comprising:
disposing a bonding frame on peripheral area of a first substrate, wherein surface of the bonding frame has a plurality of protrusions and an interspace that is provided between each two adjacent protrusions;
coating a liquid adhesive on laminating area surrounded by the bonding frame, wherein the interspace contains the overflow portion of the liquid adhesive; and
laminating a second substrate with the first substrate.

16. The laminating method of the electronic device of claim 15, further comprising the steps of partly solidifying the bonding frame before the laminating step, completely solidifying the bonding frame after the laminating step, and solidifying the liquid adhesive simultaneously.

17. The laminating method of the electronic device of claim 15, wherein the solidification steps of the bonding frame and the liquid adhesive comprise ultraviolet, infrared radiation or baking processes.

18. The laminating method of the electronic device of claim 15, wherein the disposing step comprises printing, dispensing, ejecting and chemical etching processes.

19. The laminating method of the electronic device of claim 15, wherein the protrusions are continuously aligned with equal spaces.

20. The laminating method of the electronic device of claim 15, wherein the protrusions are indented or have a bead chain-like structure.
